(19) United States
(12) Patent Application Publication
(10) Pub. No.: US 2024/0281711 A1
(43) Pub. Date: Aug. 22, 2024

(54) CLASS LABEL ESTIMATION APPARATUS, ERROR CAUSE ESTIMATION METHOD AND PROGRAM

(71) Applicant: NIPPON TELEGRAPH AND TELEPHONE CORPORATION, Tokyo (JP)

(72) Inventors: Mihiro UCHIDA, Tokyo (JP); Takayuki UMEDA, Tokyo (JP); Shingo ANDO, Tokyo (JP); Jun SHIMAMURA, Tokyo (JP)

(21) Appl. No.: 18/548,148

(22) PCT Filed: Mar. 23, 2021
(86) PCT No.: PCT/JP2021/012038

§ 371 Date: Aug. 28, 2023

(51) Int. Cl. G06N 20/00

(52) U.S. Cl. CPC G06N 20/00

(57) ABSTRACT

There is provided a class label estimation device that estimates a class label of input data and estimates a cause of an estimation error, the class label estimation device including: a distribution estimation unit that estimates a distribution followed by a training set; a distance estimation unit that estimates a distance of the input data from the training set based on the distribution; an unknown degree estimation unit that estimates an unknown degree of the input data based on the distance; an unknown degree correction unit that corrects the unknown degree based on the distribution; and an error cause estimation unit that estimates a cause of an estimation error using the corrected unknown degree.

### TECHNICAL FIELD

The present invention relates to a technology of estimating a class label representing a category of a medium such as an image or vocal sound.

### BACKGROUND ART

As one of technologies for estimating a class label, there is a technology called auxiliary classifier generative adversarial network (ACGAN) (Non Patent Literature 1).

A class label estimation device using ACGAN includes: a first mechanism that identifies whether input data is data generated from a noise signal and a label signal or data of a training set that is actual data; and a second mechanism that estimates a category label assigned to the data.

In the class label estimation device, at the time of inference, it is possible to estimate an unknown degree (out-of-distribution likelihood) indicating whether the input data is unknown by the first mechanism, and to estimate whether the input data is affected by label noise (label error in the training set) by using flatness of a softmax vector in the second mechanism.

### CITATION LIST

### Non Patent Literature

Non Patent Literature 1: Odena, Augustus, Christopher Olah, and Jonathon Shlens. “Conditional image synthesis with auxiliary classifier gans.” International conference on machine learning. 2017.
Non Patent Literature 2:Gal, Yarin, Riashat Islam, and Zoubin Ghahramani. “Deep Bayesian Active Learning with Image Data.” International Conference on Machine Learning. 2017.
Non Patent Literature 3: Ghosh, Aritra, Himanshu Kumar, and P. S. Sastry. “Robust loss functions under label noise for deep neural networks.” Proceedings of the Thirty-First AAAI Conference on Artificial Intelligence. 2017.
Non Patent Literature 4: Zhang, Zhilu, and Mert Sabuncu. “Generalized cross entropy loss for training deep neural networks with noisy labels.” Advances in neural information processing systems 31 (2018): 8778-8788.

### SUMMARY OF INVENTION

### Technical Problem

For example, it is assumed that image recognition or voice recognition is performed by the class label estimation device. At this time, in a case where erroneous recognition is performed, it is necessary to improve a recognizer (identifier). However, it is difficult for a human operator to identify the cause of erroneous recognition. Therefore, it is conceivable to cause the class label estimation device to simultaneously calculate and output a recognition result (class label) and a cause of erroneous recognition (out-of-distribution, label noise, no problem). Note that “out-of-distribution” is data generated from a generation distribution different from the training set.

For example, it is conceivable to estimate a cause of erroneous recognition (out-of-distribution, label noise, no problem) by using an unknown degree and a label noise degree (label noise likelihood) obtained by the first mechanism and the second mechanism described above.

However, in the related art, the class label estimation device using ACGAN has a problem that it is difficult to appropriately evaluate the unknown degree for unexpected out-of-distribution data.

The present invention has been made in view of the above points, and an object thereof is to provide a class label estimation technology capable of appropriately evaluating the unknown degree.

### Solution to Problem

According to the disclosed technology, there is provided a class label estimation device that estimates a class label of input data and estimates a cause of an estimation error, the class label estimation device including: a distribution estimation unit that estimates a distribution followed by a training set; a distance estimation unit that estimates a distance of the input data from the training set based on the distribution; an unknown degree estimation unit that estimates an unknown degree of the input data based on the distance; an unknown degree correction unit that corrects the unknown degree based on the distribution; and an error cause estimation unit that estimates a cause of an estimation error using the corrected unknown degree.

### Advantageous Effects of Invention

According to the disclosed technology, there is provided a class label estimation technology capable of appropriately evaluating the unknown degree.

### BRIEF DESCRIPTION OF DRAWINGS

FIG. 1 is a diagram for describing a related technology.

FIG. 2 is a conceptual diagram of out-of-distribution likelihood.

FIG. 3 is a configuration diagram of a class label estimation device according to an embodiment of the present invention.

FIG. 4 is a diagram illustrating a configuration at the time of learning.

FIG. 5 is a diagram illustrating a configuration at the time of inference.

FIG. 6 is a diagram for describing an effect.

FIG. 7 is a configuration diagram of a class label estimation device according to a modification example.

FIG. 8 is a configuration diagram of a class label estimation device according to a modification example.

FIG. 9 is a configuration diagram of a class label estimation device according to a modification example.

FIG. 10 is a configuration diagram of a class label estimation device according to a modification example.

FIG. 11 is a diagram illustrating a hardware configuration example of the device.

### DESCRIPTION OF EMBODIMENTS

Hereinafter, an embodiment of the present invention (present embodiment) will be described with reference to the drawings. The embodiment described below is merely an example, and the embodiment to which the present invention is applied is not limited to the following embodiment.

Hereinafter, in describing an embodiment of the present invention, first, a related technology using ACGAN (Non Patent Literature 1) which is the related art will be described. Note that a class label estimation device according to the related technology described below is not disclosed in Non Patent Literature 1.

### (Regarding Related Technology)

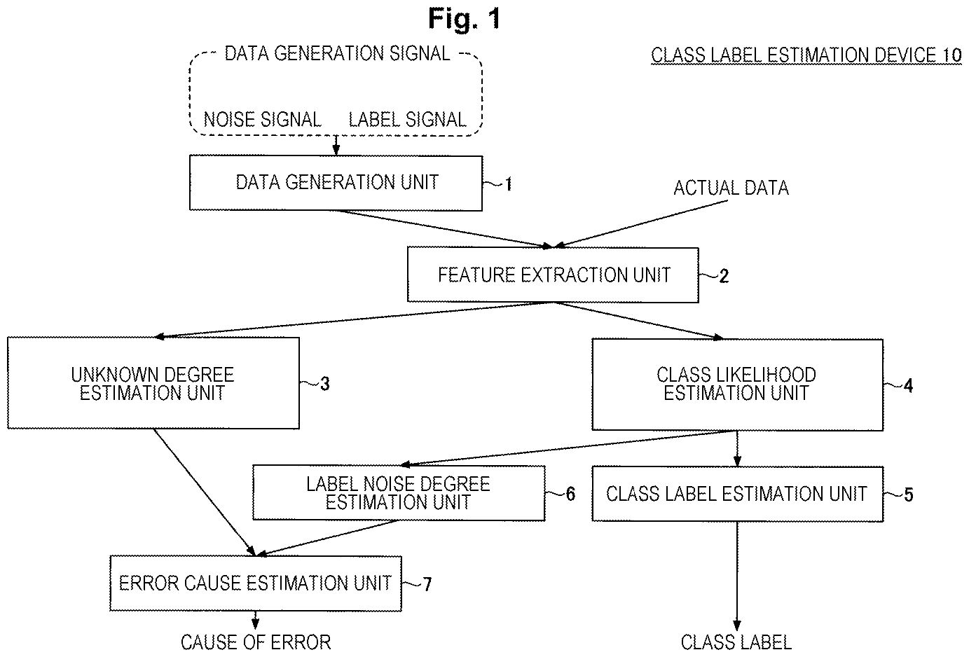

FIG. 1 illustrates a configuration example of a class label estimation device 10 according to a related technology. As illustrated in FIG. 1, the class label estimation device 10 includes a data generation unit 1, a feature extraction unit 2, an unknown degree estimation unit 3, a class likelihood estimation unit 4, a class label estimation unit 5, a label noise degree estimation unit 6, and an error cause estimation unit 7. Each of these functional units is constituted by a neural network. Each of the functional units will be described below. Note that the unknown degree estimation unit 3 may be referred to as an out-of-distribution likelihood estimation unit.

### <Data Generation Unit 1>

The data generation unit 1 generates data similar to actual data using a noise signal and a label signal. At the time of learning, the data generation unit 1 performs learning such that the output data from the data generation unit 1 is estimated to be training data by the unknown degree estimation unit 3 (a mechanism to identify whether the input data is generated data or data of a training set that is actual data). The data generation unit 1 is not used at the time of inference.

### <Feature Extraction Unit 2>

The feature extraction unit 2 extracts features of the input data. The feature extraction unit 2 is learned to be able to extract features useful for unknown degree estimation and class label estimation.

### <Unknown Degree Estimation Unit 3>

The unknown degree estimation unit 3 identifies whether the input data is data generated by the data generation unit 1 or data of a training set which is actual data.

At the time of learning, it is possible to explicitly learn that the out-of-distribution data outside the training set is unknown by using the generated data. A continuous value is obtained by the unknown degree estimation unit 3, and whether the input data is generated data or actual data can be selected by threshold value processing on the continuous value. A continuous value obtained by the unknown degree estimation unit 3 is an unknown degree.

### <Class Likelihood Estimation Unit 4>

The class likelihood estimation unit 4 estimates the likelihood for each label with respect to the input data. The class likelihood estimation unit 4 learns both generated data and actual data. The class likelihood estimation unit 4 has a softmax layer of the deep learning model, and calculates the likelihood in the softmax layer.

### <Class Label Estimation Unit 5>

The class label estimation unit 5 estimates a class label for input data based on the likelihood output from the class likelihood estimation unit 4.

### <Label Noise Degree Estimation Unit 6>

The label noise degree estimation unit 6 estimates a label noise degree which is an influence degree of label noise (label error in the training set) based on the likelihood output from the class likelihood estimation unit 4.

The softmax vector output by the class likelihood estimation unit 4 is a sharp vector in which the likelihood of any class such as [1.00, 0.00, 0.00] is overwhelmingly close to 1 when there is no influence of label noise. On the other hand, when there is an influence of label noise, the likelihood of any class such as [0.33, 0.33, 0.33] becomes a flat vector having similar values.

That is, flatness of the softmax vector represents the label noise degree. Specifically, the label noise degree estimation unit 6 outputs the smallness of the maximum value of the softmax vector, entropy, and the like as an evaluation value representing the smallness of the label noise degree.

### <Error Cause Estimation Unit 7>

Using the unknown degree estimated by the unknown degree estimation unit 3 and the label noise degree estimated by the label noise degree estimation unit 6, the error cause estimation unit 7 estimates whether the inferred data may be erroneously recognized due to the unknown state, may be erroneously recognized due to label noise, or is not erroneously recognized due to no problem. For example, the output is determined by performing threshold value processing on each of the unknown degree and the label noise degree.

### <Regarding Learning Method>

The class label estimation device 10 of the related technology performs learning to minimize the following loss functions. Loss_{disc} is a loss function of the identifier (a functional unit that learns other than the data generation unit 1 in FIG. 1), Loss_{gen}=is a loss function of the generator (the data generation unit 1 in FIG. 1), and learning is alternately performed.

$${Loss}_{disc} = {E}_{x ∼ p ( x )} [ - log p ( y = {y}_{GT} \vert x ) ] + E [ - log p ( rf = {rf}_{GT} \vert \{ x , G ( z ) \} ) ]$$

$${Loss}_{gen} = {E}_{z ∼ p ( z )} [ - log p ( y = {y}_{GT} \vert G ( z ) ) ] - {E}_{z ∼ p ( z )} [ - log p ( rf = {rf}_{GT} \vert G ( z ) ) ]$$

The meanings of the symbols are as follows.
G(·): Function of data generation unit
z: Noise signal
x: Input data
rf_{GT}: Correct answer value of authenticity
y_{GT}: Correct answer value of class label

The first term on the right side of the Loss_{disc} is a loss function for correctly predicting the class, and the second term is a loss function for correctly predicting the authenticity. The first term on the right side of Loss_{gen} is a loss function for correctly predicting the class, and the second term of Loss_{gen} is a loss function for erroneously predicting authenticity.

### (Regarding Problem)

In the related technology, there is a problem that it is difficult for the unknown degree estimation unit 3 to appropriately evaluate the unknown degree for unexpected out-of-distribution data. This aspect is described in detail below.

In the unknown degree estimation unit 3, the real/fake output by the GAN is set as the unknown degree. This is because real/fake can be interpreted as likelihood of a training set and not-likelihood of a training set

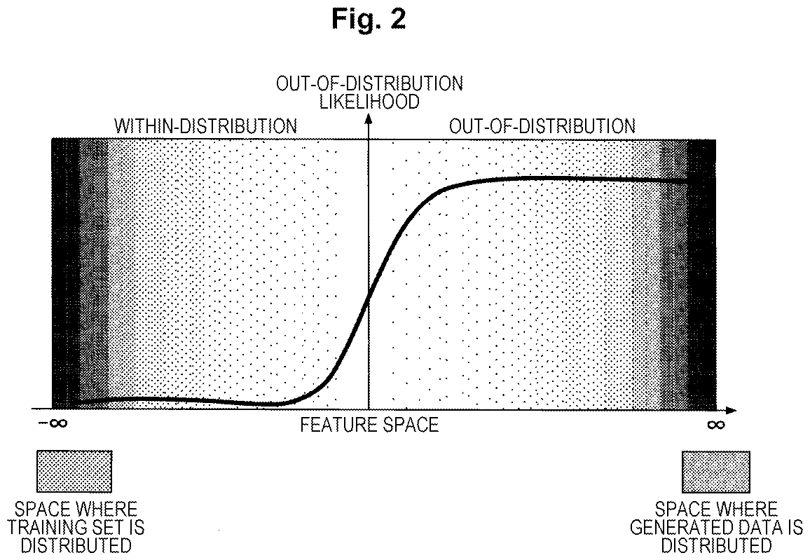

Here, as illustrated in FIG. 2, the learning target of the GAN can be interpreted as “The generated data is distributed around—in the feature space in order to set the out-of-distribution likelihood to be 1 in the generated data”. Furthermore, the training set (training data set) can be interpreted as “The training set is distributed around −∞ in the feature space in order to make the out-of-distribution likelihood to be 0 in the training set”. In a case where data similar to the learned training set or generated data (=unknown data assumed at the time of learning) is input, the out-of-distribution likelihood learned by such a method is expected to function appropriately.

However, in a case where out-of-distribution data that cannot be assumed at the time of learning is input to the identifier, there is a case where the out-of-distribution data is not included in a section in which the generated data is distributed in the feature space (the out-of-distribution data falls in a part (a part close to white) in which shading is light in FIG. 2). At this time, there is a possibility that the out-of-distribution data that cannot be assumed at the time of learning falls into a region determined as “rather, within distribution (out-of-distribution likelihood <0.5)”. This cannot correctly estimate the cause of the error.

Furthermore, a method of performing calibration (for example, calibration is performed such that an average value and a maximum value of out-of-distribution likelihood become unknown degree=0.5) based on the out-of-distribution likelihood of the training set is also conceivable. However, since it is necessary to evaluate the out-of-distribution likelihood by inferring the entire training set, the calculation amount is proportional to the number of pieces of data of the training set, and linear time is required for determining the threshold value. This means that it takes more time to determine the threshold value as the number of pieces of data in the training set increases. Considering that the classifier can be improved by learning the out-of-distribution data in addition to the training set (refer to Non Patent Literature 2), the calculation load increases due to improvement of the classifier.

### Configuration Example of Class Label Estimation Device 100

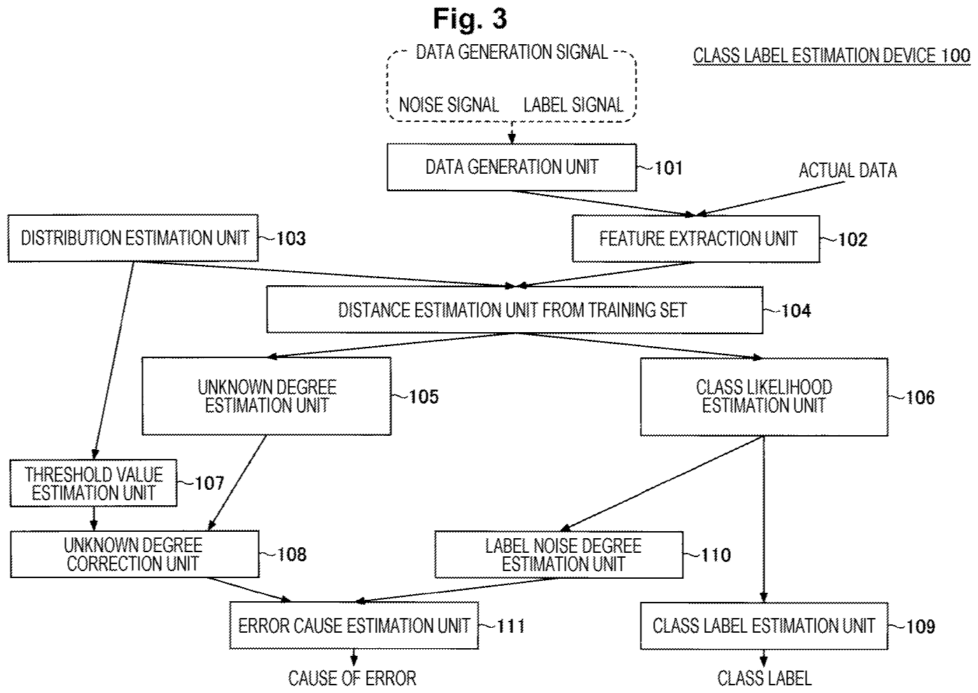

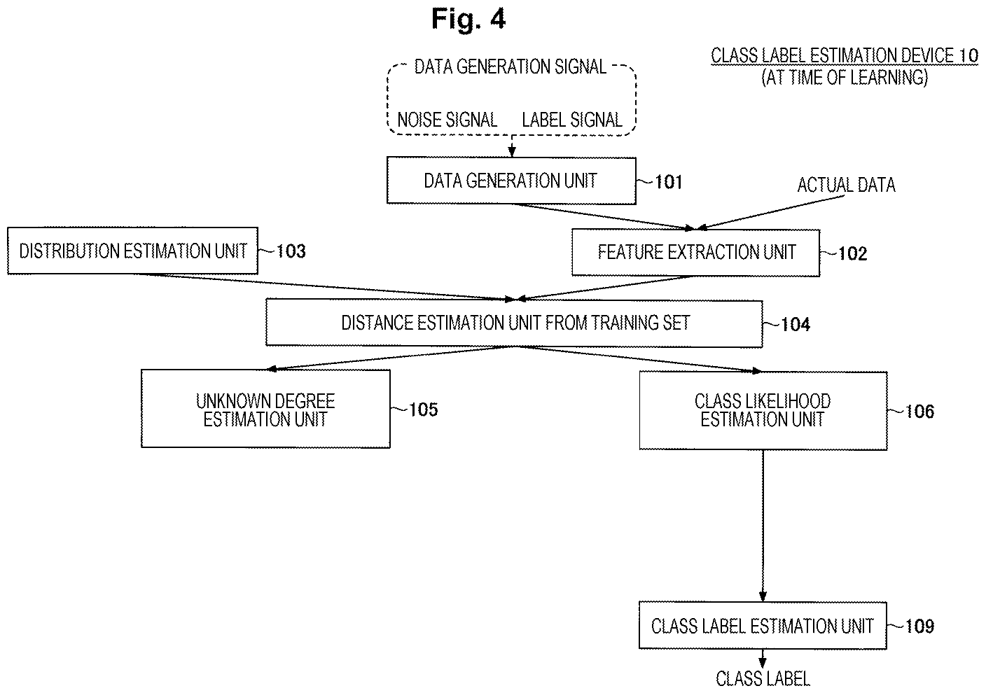

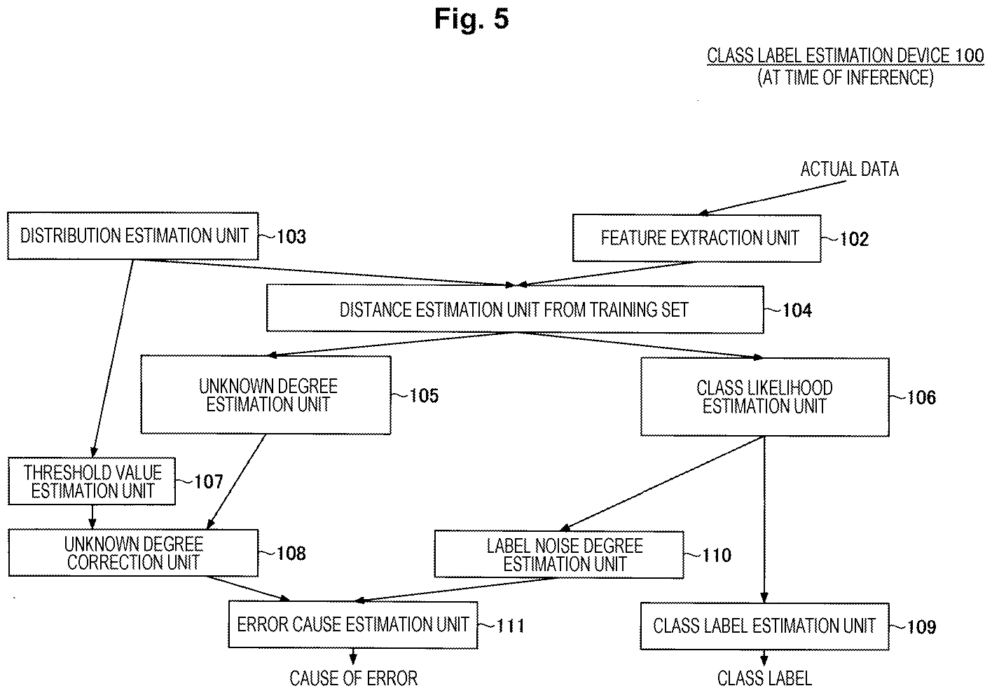

FIG. 3 illustrates a configuration of a class label estimation device 100 according to the present embodiment that solves the above problem. In addition, a configuration at the time of learning is illustrated in FIG. 4, and a configuration at the time of inference is illustrated in FIG. 5.

As illustrated in FIG. 3, the class label estimation device 100 includes a data generation unit 101, a feature extraction unit 102, a distribution estimation unit 103, a distance estimation unit 104 to a training set, an unknown degree estimation unit 105, a class likelihood estimation unit 106, a threshold value estimation unit 107, an unknown degree correction unit 108, a class label estimation unit 109, a label noise degree estimation unit 110, and an error cause estimation unit 111. Each of these functional units is constituted by a neural network.

The configuration illustrated in FIG. 3 corresponds to a configuration in which the distribution estimation unit 103, the distance estimation unit 104 from the training set, the threshold value estimation unit 107, and the unknown degree correction unit 108 are added to the configuration illustrated in FIG. 1.

The distribution estimation unit 103 estimates a distribution followed by the training set in the feature space. The distance estimation unit 104 from the training set estimates the distance between the input data and the universal set or subset of the training set based on the distribution estimated by the distribution estimation unit 103. The threshold value estimation unit 107 determines a threshold value with a constant time that does not depend on the number of pieces of data of the training set based on the distribution estimated by the distribution estimation unit 107. The unknown degree correction unit 108 corrects the unknown degree based on the threshold value obtained by the threshold value estimation unit 107. Each of the units will be described below.

### <Data Generation Unit 101>

The data generation unit 101 generates data similar to actual data using a noise signal and a label signal. At the time of learning, the data generation unit 101 performs learning such that the output data from the data generation unit 101 is estimated to be training data by the unknown degree estimation unit 105. The data generation unit 101 is not used at the time of inference.

### <Feature Extraction Unit 102>

The feature extraction unit 102 extracts features of the input data. The feature extraction unit 102 is learned to be able to extract features useful for unknown degree estimation (out-of-distribution likelihood estimation) and class label estimation.

### <Distribution Estimation Unit 103>

The distribution estimation unit 103 estimates the distribution followed by the training set. As an example of a processing method for distribution estimation, the distribution followed by the training set may be approximated, or learning may be performed such that the training set follows a specific distribution. As the output from the distribution estimation unit 103, a probability density function may be directly output, a function representing a distribution shape may be output, or parameters (for example, average and variance) that determine the shape of the distribution may be output.

<Distance Estimation Unit 104 from Training Set>

The distance estimation unit 104 from the training set is a mechanism that estimates the distance between the input data and the training set based on the distribution estimated by the distribution estimation unit 103. Here, the distance to the training set is a distance (or divergence) to the universal set (or subset) of the training set, a generation probability p(x) of the input data x, a generation probability (for example, p(x|z) in a case where the latent variable z is used as the condition, and p(x|y) in a case where the class y is used as the condition) in which some variables (for example, a latent variable, a class, or the like) are used as conditions, or the like. The distance estimation unit 104 from the training set may calculate the distance using mathematical properties, or may approximate a function for calculating the distance by machine learning or the like.

### <Unknown Degree Estimation Unit 105>

The unknown degree estimation unit 105 calculates the out-of-distribution likelihood of the input data based on the distance or the probability estimated by the distance estimation unit 104 from the training set. For example, the conditional probability of the condition that the distance is minimized may be used as the out-of-distribution likelihood, the probability of being marginalized by the variable serving as the condition may be used as the out-of-distribution likelihood, or the distance itself estimated by the distance estimation unit 104 from the training set may be used as the out-of-distribution likelihood. The “out-of-distribution likelihood” may be referred to as an “unknown degree”.

### <Class Likelihood Estimation Unit 106>

The class likelihood estimation unit 106 estimates the likelihood for each label for the input data based on the distance estimated by the distance estimation unit 104 from the training set. The class likelihood estimation unit 106 learns only the actual data. The class likelihood estimation unit 106 has a softmax layer of the deep learning model, and calculates the likelihood in the softmax layer.

### <Threshold Value Estimation Unit 107>

The threshold value estimation unit 107 estimates a threshold value for realizing the coverage (for example, 90%) of any training set based on the distribution estimated by the distribution estimation unit 103. As an estimation method, for example, there is a method of solving an equation for obtaining an integration section in which an integral of a distribution function matches a designated coverage and analytically obtaining the same.

### <Unknown Degree Correction Unit 108>

The unknown degree correction unit 108 corrects the unknown degree (out-of-distribution likelihood) estimated by the unknown degree estimation unit 105 using the threshold value output from the threshold value estimation unit 107. Specifically, the unknown degree is corrected to be divided into within-distribution and out-of-distribution based on the threshold value output from the threshold value estimation unit 107.

As an example of the correction method, for example, correction by binarization may be performed, or correction may be performed using a sigmoid function (sigmoid (·)) such that the threshold value becomes 0.5.

In the correction by binarization, 1 is output when D(x)>Thr_{D}, and 0 is output when D(x)≤Th_{D}. Note that the equal sign may be attached to either equation. Here, D(·) is a distance function indicating out-of-distribution likelihood, and this value is output from the out-of-distribution likelihood estimation unit 105. Th_{D} is a threshold value output from the threshold value estimation unit 107.

In the correction using the sigmoid function, sigmoid (D(x)−Th_{D}) is calculated and output.

### <Class Label Estimation Unit 109>

The class label estimation unit 109 estimates a class label for input data based on the likelihood output from the class likelihood estimation unit 106.

### <Label Noise Degree Estimation Unit 110>

The label noise degree estimation unit 110 estimates a label noise degree which is an influence degree of label noise (label error in the training set) based on the likelihood output from the class likelihood estimation unit 106.

The softmax vector output by the class likelihood estimation unit 106 is a sharp vector in which the likelihood of any class such as [1.00, 0.00, 0.00] is overwhelmingly close to 1 when there is no influence of label noise. On the other hand, when there is an influence of label noise, the likelihood of any class such as [0.33, 0.33, 0.33] becomes a flat vector having similar values.

That is, flatness of the softmax vector represents the label noise degree. Specifically, the label noise degree estimation unit 6 outputs the smallness of the maximum value of the softmax vector, entropy, and the like as an evaluation value representing the smallness of the label noise degree.

### <Error Cause Estimation Unit 111>

Using the unknown degree corrected by the unknown degree correction unit 108 and the label noise degree estimated by the label noise degree estimation unit 110, the error cause estimation unit 111 estimates whether the inferred data may be erroneously recognized due to the unknown state, may be erroneously recognized due to label noise, or is not erroneously recognized due to no problem. For example, the output is determined by performing threshold value processing on each of the unknown degree and the label noise degree.

### (Learning Method of Class Label Estimation Device 100)

In the class label estimation device 100 according to the present embodiment, learning is performed by adding a term for estimating a distribution with respect to the learning method described in the related technology. In addition, in learning of the identifier of the GAN, the learning is also performed based on the distance estimated by the distance estimation unit 104 from the training set such that the distance becomes short in the training set and the distance becomes long in the generated data. Similarly, in learning of the generator of the GAN, the learning is performed such that data can be generated such that the distance estimated by the distance estimation unit 104 from the training set becomes short. At this time, learning may be performed using a loss function that does not consider label noise, or a loss function that robustly learns label noise (for example, average absolute error (Non Patent Literature 3) or Qloss (Non Patent Literature 4)) may be used.

### Effects of Embodiment

According to the technology according to the present embodiment, the unknown degree can be calibrated with a constant time. As a result, it is possible to improve the estimation performance of the cause of erroneous recognition (out-of-distribution, label noise, no problem).

### (Confirmation of Effect)

An experiment was performed to confirm whether the unknown degree was correctly calibrated by the class label estimation device 100 according to the present embodiment.

Here, when the class likelihood is estimated using DNN, there is a case where the likelihood of any class is low with respect to the out-of-distribution data. When the likelihood of any class is also low in the out-of-distribution data, the out-of-distribution can be detected even when using the label noise degree, which adversely affects the estimation of the cause of erroneous recognition. Therefore, in a case where the calibrated unknown degree is high, the likelihood of a certain class is set to be high. When the unknown degree is correctly calibrated, the out-of-distribution data should not be detected by the label noise degree.

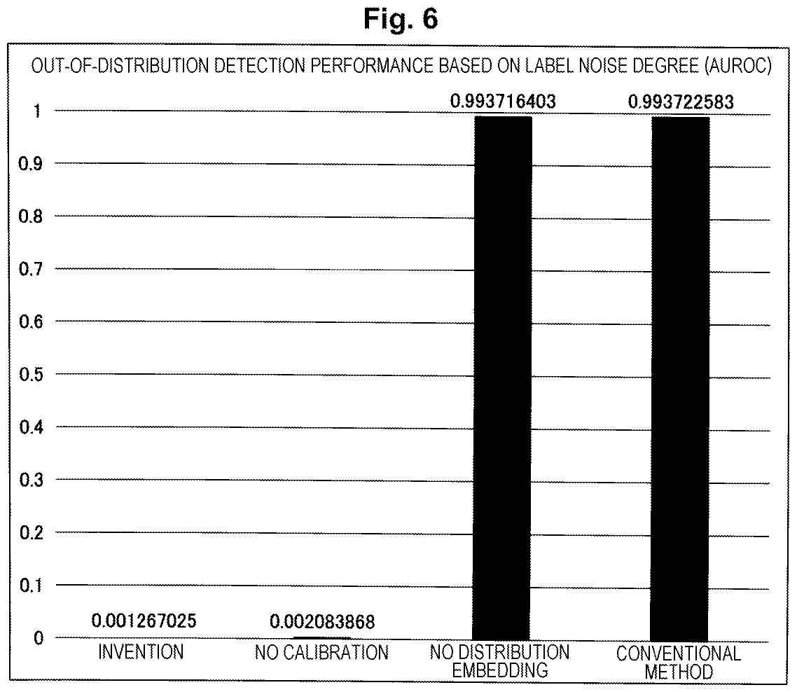

Experimental results thereof are illustrated in FIG. 6. As illustrated in FIG. 6, it can be confirmed that the out-of-distribution detection performance based on the label noise degree has deteriorated according to the present invention. This means that a better calibrated unknown degree than that in the conventional method was obtained.

### Summary of Embodiment

In the design of the out-of-distribution likelihood in the related art, the unknown degree calculated using the generated data (=out-of-distribution data assumed at the time of learning) is used as it is. Therefore, there is a problem that the validity of the unknown degree is lowered in a case where unexpected out-of-distribution data is input. In order to avoid this, when the threshold value is determined and calibrated by using the statistical value of the out-of-distribution likelihood of the training set, a problem that a calculation cost is required to determine the threshold value in proportion to the number of pieces of data of the training set occurs.

To solve these simultaneously, a distribution followed by the training set in the feature space is estimated, a threshold value is determined based on a distance to the training set, and the unknown degree is calibrated. As a result, it is possible to improve the estimation performance of the cause of erroneous recognition.

### Modification Example

Another modification example of the class label estimation device using the distance estimation unit with the training set will be described. As described below, a class likelihood correction unit 209 is provided in the modification example. The class label estimation device 100 described above may include both the unknown degree correction unit 108 and the class likelihood correction unit 209 described below.

### <Device Configuration>

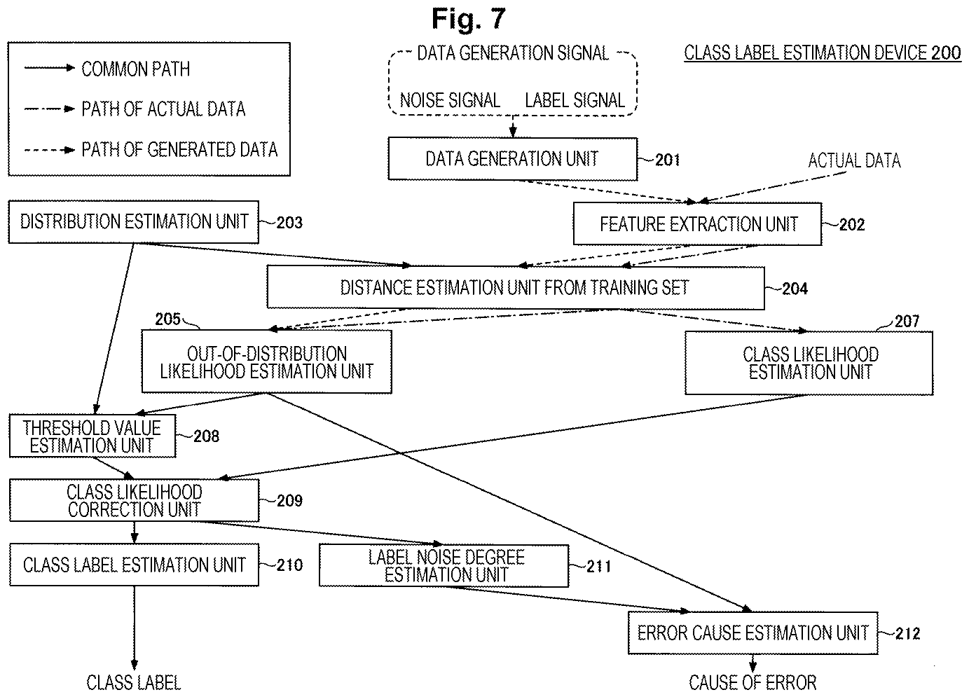

FIG. 7 is a configuration diagram of a class label estimation device 200 according to a modification example. As illustrated in FIG. 7, the class label estimation device 200 includes a data generation unit 201, a feature extraction unit 202, a distribution estimation unit 203, a distance estimation unit 204 from a training set, an out-of-distribution likelihood estimation unit 205, a class likelihood estimation unit 207, a threshold value estimation unit 208, a class likelihood correction unit 209, a class label estimation unit 210, a label noise degree estimation unit 211, and an error cause estimation unit 212. Each of these functional units is constituted by a neural network.

### <Function of Each Unit>

The data generation unit 201, the feature extraction unit 202, the distribution estimation unit 203, the distance estimation unit 204 from the training set, the out-of-distribution likelihood estimation unit 205, the class likelihood estimation unit 207, the threshold value estimation unit 208, the class label estimation unit 210, the label noise degree estimation unit 211, and the error cause estimation unit 212 have the same functions as those of the data generation unit 101, the feature extraction unit 102, the distribution estimation unit 103, the distance estimation unit 104 from the training set, the unknown degree estimation unit 105, the class likelihood estimation unit 106, the threshold value estimation unit 107, the class label estimation unit 109, the label noise degree estimation unit 110, and the error cause estimation unit 111 in the first embodiment illustrated in FIG. 3.

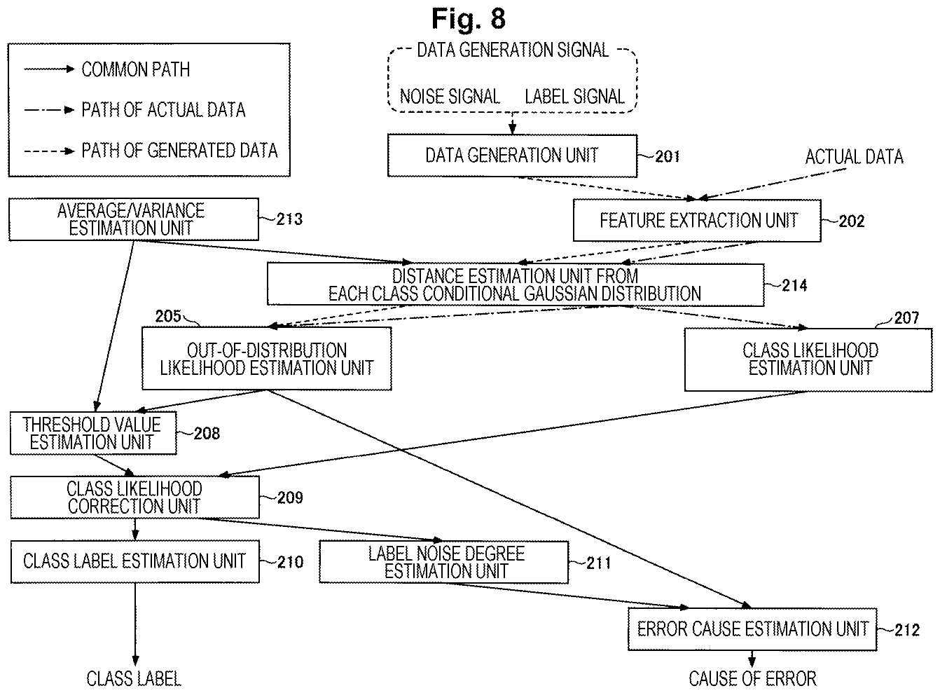

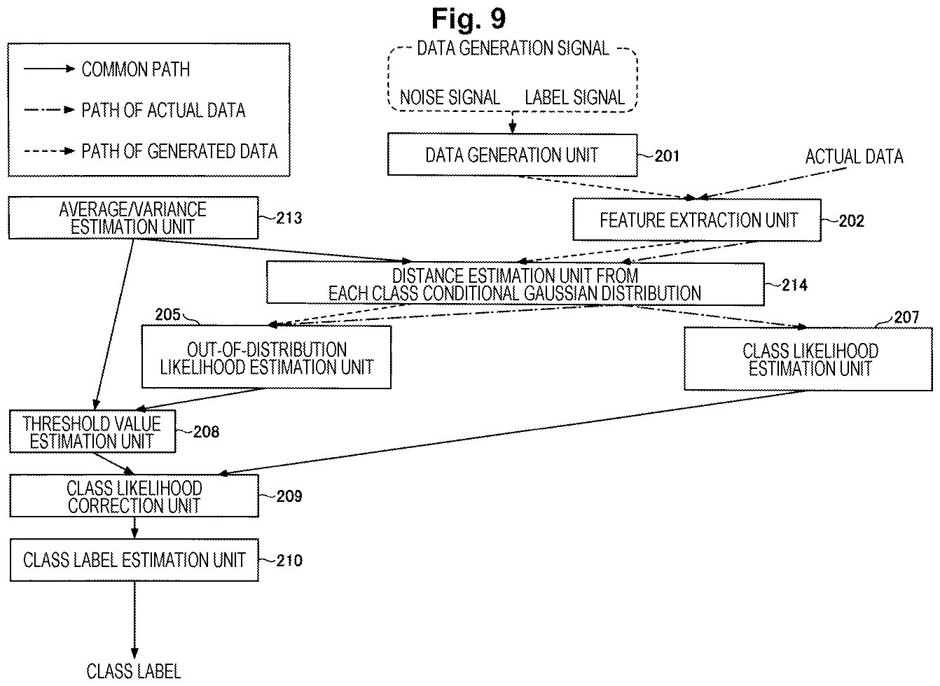

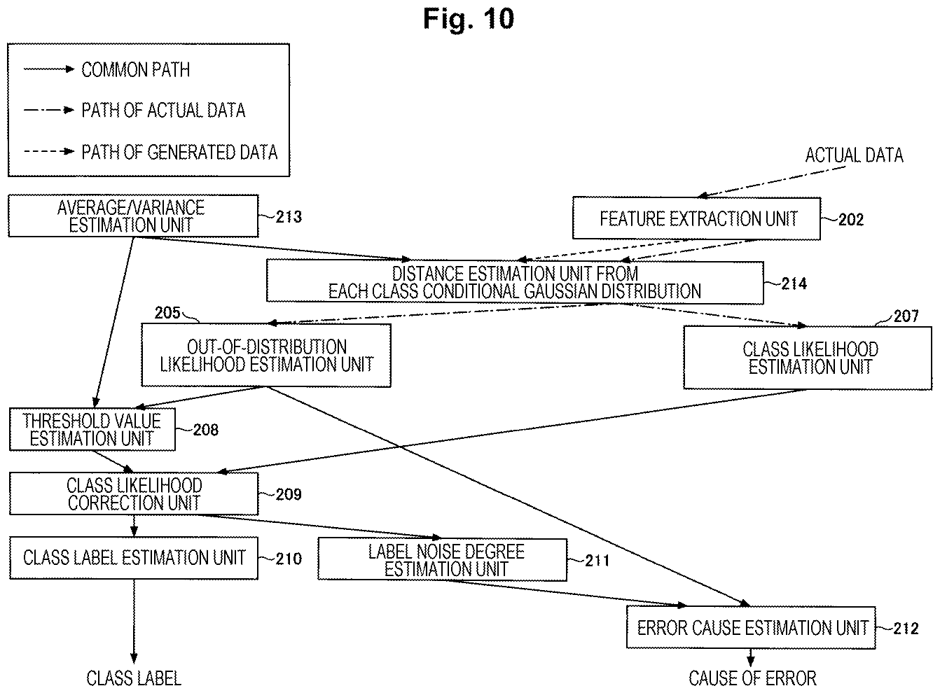

In addition, as a specific example of the distribution estimation unit 203 and the distance estimation unit 204 from the training set, as illustrated in FIG. 8, an average/variance estimation unit 213 and a distance estimation unit 214 from each class conditional Gaussian distribution may be used. Hereinafter, the function of each unit based on the configuration of FIG. 8 will be described. Note that FIG. 9 illustrates a configuration at the time of learning, and FIG. 10 illustrates a configuration at the time of inference.

The data generation unit 201 generates data belonging to the distribution of the class designated by the label signal at the time of learning. The feature extraction unit 202 extracts features of the input data.

The average/variance estimation unit 213 performs learning such that a parameter of a distribution with a class condition can be estimated at the time of learning, and outputs a (learned) parameter of a distribution followed by the training set at the time of inference.

The distance estimation unit 214 from each class conditional Gaussian distribution converts the feature extracted from the feature extraction unit 202 into a distance from each distribution. The out-of-distribution likelihood estimation unit 205 performs learning such that the actual data belongs to the distribution of the correct answer class and the generated data does not belong to the distribution of any class.

The threshold value estimation unit 208 determines within-distribution or out-of-distribution threshold value based on the parameter of the class conditional distribution. The class likelihood correction unit 209 corrects the likelihood based on the threshold value from the threshold value estimation unit 208. Note that, at the time of inference, different correction values may be returned to the class label estimation unit 210 and the label noise degree estimation unit 211.

For example, the class label estimation unit 210 selects a class label having the maximum corrected likelihood. Based on the corrected class likelihood, the label noise degree estimation unit 211 calculates a label noise degree (label noise likelihood) with a low maximum value of likelihood, entropy of likelihood, or the like. The error cause estimation unit 212 estimates whether the inferred data is unknown, label noise or neither of them based on threshold value processing or the like.

### <Loss Function>

The loss function of the identifier (the configuration illustrated in FIG. 10) in the modification example is as follows.

$${Loss}_{disc} = {E}_{x ∼ p ( x )} [ - log p ( y = {y}_{GT} \vert x ) ] + {E}_{x ∼ p ( x )} [ - log N ( x \vert {μ}_{y \_ GT ,} {σ}_{y \_ GT}^{2} ) ] - {E}_{z ∼ p ( z )} [ - log p ( G ( z ) ) ]$$

$$p ( G ( z ) ) = {E}_{p ( y )} [ - log p ( G ( z ) \vert y ) ] = {E}_{p ( y )} [ - log N ( G ( z ) \vert {μ}_{y} , {σ}_{y}^{2} ) ]$$

The first term on the right side of the Loss_{disc} is a loss function for predicting the data of the training set to the correct class, the second term is a loss function for the data of the training set to belong to a distribution of the correct class, and the third term is a loss function for the generated data to leave any distribution. In addition, learning may be performed using a loss function that does not consider label noise, or a loss function that robustly learns label noise (for example, average absolute error (Non Patent Literature 3) or Qloss (Non Patent Literature 4)) may be used.

The loss function of the generator (data generation unit 201) in the modification example is as follows.

$${Loss}_{gen} = {E}_{z \sim p ( z )} [ - log p ( G ( z ) \vert y = {y}_{GT} ) ]$$

This is a loss function for causing the generated data to belong to the distribution of the designated class. Note that the above may be indirectly minimized using the following loss function or directly minimized.

$${Loss}_{gen} = {E}_{z \sim p ( z )} [ - log p ( y = {y}_{GT} \vert G ( z ) ) ] + {E}_{z \sim p ( z )} [ - log p ( G ( z ) ) ]$$

The first term on the right side of the above equation is a loss function that causes the generated data to be classified into the designated class, and the second term is a loss function that causes the generated data to be close to the distribution followed by the training set.

### Example of Threshold Value

An example of the threshold value Th_{D} calculated by the threshold value estimation unit 208 in the modification example is as follows.

$${Th}_{D} = k {σ}^{2}$$

Here, σ²=is the standard deviation of the Gaussian distribution, and k is any constant (hyperparameter).

However, empirically, it is known that the threshold value is determined such that approximately 66% of the training set are within the distribution when k=1, approximately 96% of the training set are within the distribution when k=2, and approximately 99% of the training set are within the distribution when k=3. These sections correspond to the 1σ² section, the 2σ² section, and the 3σ² section of the normal distribution. Note that the above-described calculation example of the threshold value may be applied to the above-described class label estimation device 100.

### Example of Likelihood Correction

For correction of the class likelihood by the class likelihood correction unit 209, either correction by the following soft combination or correction by hard combination may be used.

Example of correction by soft combination:

$$sigmoid ( D ( x ) - {Th}_{D} ) \times {Softmax}_{sharp} + ( 1 - sigmoid ( D ( x ) - {Th}_{D} ) ) \times softmax$$

$$( 1 - {Th}_{D} ) \times softmax + rf \times {softmax}_{sharp}$$

However, Softmaxₛₕₐᵣₚ is a one-hot vector, and Softmax is an output of the class likelihood estimation unit 207. D(·) is a distance function representing the out-of-distribution likelihood, and D(x) is an output of the out-of-distribution likelihood estimation unit 205. sigmoid(·) is a sigmoid function, and Th_{D} is a threshold value.

Example of correction by hard combination:

When D(x)>Th_{D}, Softmaxₛₕₐᵣₚ is set, and when D(x)≤Th_{D}, softmax is set. Note that the equal sign may be attached to either equation.

### Hardware Configuration Example

The class label estimation devices 100 and 200 can be implemented, for example, by causing a computer to execute a program. This computer may be a physical computer, or may be a virtual machine in a cloud.

In other words, the class label estimation devices 100 and 200 can be implemented by executing a program corresponding to the processing to be performed in the class label estimation devices 100 and 200, using hardware resources such as a CPU and a memory built into the computer. The above program can be stored and distributed by being recorded in a computer-readable recording medium (portable memory or the like). Furthermore, the above program can also be provided through a network such as the Internet or e-mail.

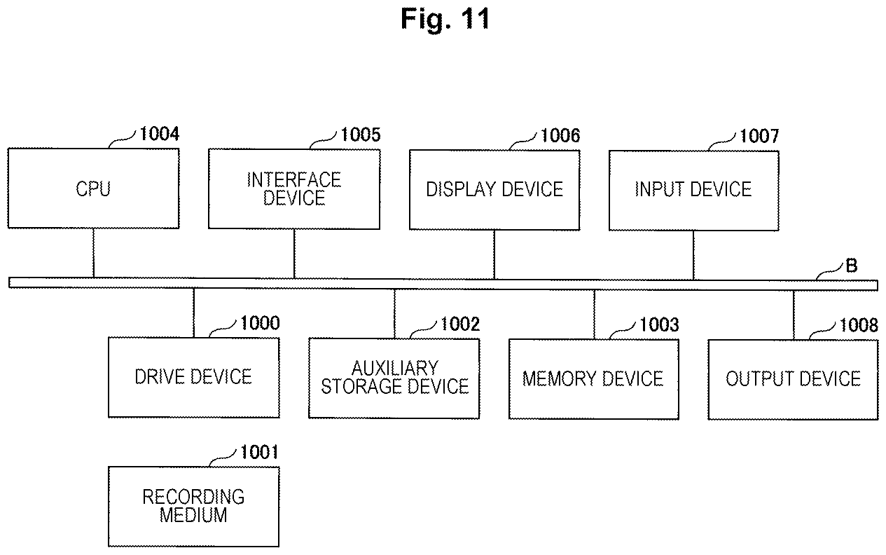

FIG. 11 is a diagram illustrating a hardware configuration example of the computer. The computer in FIG. 11 includes a drive device 1000, an auxiliary storage device 1002, a memory device 1003, a CPU 1004, an interface device 1005, a display device 1006, an input device 1007, an output device 1008, and the like which are connected to each other by a bus BS. Note that some of these devices are not necessarily included. For example, in a case where display is not to be performed, the display device 1006 may not be included.

The program for realizing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads and stores the program from the auxiliary storage device 1002. The CPU 1004 implements a function related to the device in accordance with a program stored in the memory device 1003. The interface device 1005 is used as an interface for connecting to a network, and functions as a transmission unit and a reception unit. The display device 1006 displays a graphical user interface (GUI) or the like according to the program. The input device 1007 includes a keyboard and mouse, buttons, a touch panel, or the like, and is used to input various operation instructions. The output device 1008 outputs a computation result.

### (Supplement)

In the present specification, at least a class label estimation device, an error cause estimation method, and a program described in clauses described below is described.

### (Clause 1)

A class label estimation device that estimates a class label of input data and estimates a cause of an estimation error, the class label estimation device including: a distribution estimation unit that estimates a distribution followed by a training set; a distance estimation unit that estimates a distance of the input data from the training set based on the distribution; an unknown degree estimation unit that estimates an unknown degree of the input data based on the distance; an unknown degree correction unit that corrects the unknown degree based on the distribution; and an error cause estimation unit that estimates a cause of an estimation error using the corrected unknown degree.

### (Clause 2)

The class label estimation device according to clause 1, further including: a threshold value estimation unit that estimates, based on the distribution, a threshold value to be used for correction of the unknown degree.

### (Clause 3)

The class label estimation device according to clause 2, in which the threshold value estimation unit estimates the threshold value to realize a predetermined coverage in the distribution of the training set.

### (Clause 4)

The class label estimation device according to clause 2 or 3, wherein the unknown degree correction unit corrects the unknown degree to be divided into within-distribution and out-of-distribution with reference to the threshold value.

### (Clause 5)

The class label estimation device according to any one of clauses 1 to 4, further including: a label noise degree estimation unit that estimates a label noise degree based on the class likelihood of the input data, in which the error cause estimation unit estimates a cause of an estimation error using the corrected unknown degree and the label noise degree.

### (Clause 6)

An error cause estimation method executed by a class label estimation device that estimates a class label of input data and estimates a cause of an estimation error, the error cause estimation method including: a distribution estimation step of estimating a distribution followed by a training set; a distance estimation step of estimating a distance of the input data from the training set based on the distribution; an unknown degree estimation step of estimating an unknown degree of the input data based on the distance; an unknown degree correction step of correcting the unknown degree based on the distribution; and an error cause estimation step of estimating a cause of an estimation error using the corrected unknown degree.

### (Clause 7)

A program for causing a computer to function as each unit in the class label estimation device according to any one of clauses 1 to 5.

Although the present embodiment has been described above, the present invention is not limited to such a specific embodiment, and various modifications and changes can be made within the scope of the gist of the present invention described in the claims.

### REFERENCE SIGNS LIST

10, 100, 200 Class label estimation device
1, 101, 201 Data generation unit
2, 102, 202 Feature extraction unit
3, 105 Unknown degree estimation unit
4, 106, 207 Class likelihood estimation unit
5, 109, 210 Class label estimation unit
6, 110, 211 Label noise degree estimation unit
7, 111, 212 Error cause estimation unit
103, 203 Distribution estimation unit
104, 204 Distance estimation unit from training set
107, 208 Threshold value estimation unit
108 Unknown degree correction unit
205 Out-of-distribution likelihood estimation unit
209 Class likelihood correction unit
1000 Drive device
1001 Recording medium
1002 Auxiliary storage device
1003 Memory device
1004 CPU
1005 Interface device
1006 Display device
1007 Input device
1008 Output device

1. A class label estimation device that estimates a class label of input data and estimates a cause of an estimation error, the class label estimation device comprising:
a processor; and
a memory storing program instructions that cause the processor to:
estimate a distribution followed by a training set;
estimate a distance of the input data from the training set based on the distribution;
estimate an unknown degree of the input data based on the distance;
correct the unknown degree based on the distribution; and
estimate a cause of an estimation error using the corrected unknown degree.

2. The class label estimation device according to claim 1, wherein the program instructions cause the processor to estimate, based on the distribution, a threshold value to be used for correction of the unknown degree.

3. The class label estimation device according to claim 2, wherein the processor estimates the threshold value to realize a predetermined coverage in the distribution of the training set.

4. The class label estimation device according to claim 2, wherein the processor corrects the unknown degree to be divided into within-distribution and out-of-distribution with reference to the threshold value.

5. The class label estimation device according to claim 1, wherein the program instructions cause the processor to estimate a label noise degree based on a class likelihood of the input data, and
wherein the processor estimates a cause of an estimation error using the corrected unknown degree and the label noise degree.

6. An error cause estimation method executed by a class label estimation device that estimates a class label of input data and estimates a cause of an estimation error, the error cause estimation method comprising:
estimating a distribution followed by a training set;
estimating a distance of the input data from the training set based on the distribution;
estimating an unknown degree of the input data based on the distance;
correcting the unknown degree based on the distribution; and
estimating a cause of an estimation error using the corrected unknown degree.

7. A non-transitory computer-readable recording medium storing a program for causing a computer to perform the error cause estimation method according to claim 6.
